(19) United States
(12) Patent Application Publication
(10) Pub. No.: US 2017/0280483 A1
(43) Pub. Date: Sep. 28, 2017

(54) METHOD FOR CONFIGURING RANDOM ACCESS RESPONSE, BASE STATION AND USER EQUIPMENT

(71) Applicant: Sharp Kabushiki Kaisha, Sakai City, Osaka (JP)

(72) Inventors: Renmao LIU, Shanghai (CN); Feng WANG, Shanghai (CN); Xingya SHEN, Shanghai (CN)

(73) Assignee: Sharp Kabushiki Kaisha, Sakai City, Osaka (JP)

(21) Appl. No.: 15/506,315

(22) PCT Filed: Sep. 21, 2015
(86) PCT No.: PCT/CN2015/090137

§ 371 Date: Feb. 24, 2017

(30) Foreign Application Priority Data
Sep. 22, 2014 (CN) 201410487879.7

(51) Int. Cl. H04W 74/08; H04W 36/38

(52) U.S. Cl. CPC H04W 74/0833; H04W 36/385; H04W 74/08; H04W 74/002

(57) ABSTRACT

The present disclosure provides a method for configuring a Random Access Response (RAR), a base station and a User Equipment (UE). The base station comprises a Medium Access Control (MAC) Protocol Data Unit (PDU) generation unit and a transmission unit. The MAC PDU generation unit is configured to generate a MAC PDU consisting of a MAC header and zero or more MAC Random Access Responses (RARs) corresponding to one or more Physical Random Access Channel (PRACH) resource sets. The PRACH resource sets corresponding to the MAC RARs are distinguishable based on PRACH Resource Set Indices (PRIs) in the MAC PDU. The transmission unit is configured to transmit the generated MAC PDU on a Physical Downlink Shared Channel (PDSCH). The base station can further comprise a configuration unit configured to configure, via Radio Resource Control (RRC) signaling, MAC signaling or Physical Broadcast Channel (PBCH), or by means of pre-configuration, resource allocation and other control information for the PDSCH carrying the MAC PDU and/or resource information for RAR M-PDCCH.

### TECHNICAL FIELD

The present disclosure relates to wireless communications, and more particularly, to a method for configuring a Random Access Response (RAR), a base station and a User Equipment (UE).

### BACKGROUND

With the rapid growth of mobile communications and the enormous development of technology, the world is evolving towards a network society with full connectivity. That is, anyone or anything can obtain information and share data anytime and anywhere. It is expected that, by 2020, there will be 50 billion of interconnected devices, among which only 10 billion will be mobile phones and tablet computers, while others are machines that do not interact with human, but with each other. Hence, there is a topic worth comprehensive research regarding how to design the system to support a huge number of machine communication devices.

In the Long Term Evolution (LTE) standard in the 3^{rd} Generation Partner Project (3GPP), such machine-to-machine communication is referred to as Machine Type Communication (MTC). The MTC is a data communication service without human involvement. A large-scale deployment of MTC UEs can be applied to various fields such as security, tracking, payment, measurement, consumer electronics, and in particular to applications such as video surveillance, supply chain tracking, intelligent metering and remote monitoring. The MTC requires low power consumption and supports low data transmission rate and low mobility. Currently, the LTE system is mainly designed for Human-to-Human (H2H) communication services. Hence, in order to achieve the scale benefit and application prospect of the MTC services, it is important for the LTE network to support the MTC devices to operate at low cost.

Further, some MTC devices are mounted in basements of residential buildings or locations protected by insulating films, metal windows or thick walls of traditional buildings. These devices will suffer significantly higher penetration loss in air interface than conventional device terminals, such as mobile phones and tablets, in the LTE network. The 3GGP has started researches on solution designs and performance evaluations for MTC devices with a 20 dB of additional coverage enhancement. It is to be noted that an MTC device located in an area with poor network coverage has a very low data transmission rate, a very loose delay requirement and a limited mobility. For these MTC characteristics, some signaling and/or channels of the LTE network can be further optimized to better support the MTC services.

For this purpose, in the 3GPP RAN #64 meetings in June, 2014, a new work item for Rel-13 has been proposed for the low complexity and enhanced coverage MTC (see non-patent document: RP-140990, New Work Item on Even Lower Complexity and Enhanced Coverage LTE UE for MTC, Ericsson, NSN). In the description of this work item, the LTE Rel-13 system shall allow MTC UEs supporting 1.4 MHz RF bandwidth in UL/DL (referred to as narrowband MTC UE) to operate over any system bandwidth (e.g., 1.4 MHz, 3 MHz, 5 MHz, 10 MHz, 15 MHz, 20 MHz, etc.) and provide such MTC UEs with coverage enhancement function. A uniform design is desired for low-cost MTC UEs and MTC UEs with coverage enhancement in the system design.

In the conventional LTE network, when an evolved NodeB (eNB) detects a preamble sequence transmitted from a UE, it will transmit, on Physical Downlink Shared Channel (PDSCH), a Random Access Response (RAR) message. The RAR message includes an identifier of the detected preamble sequence, time adjustment information for uplink synchronization, an initial uplink resource allocation (for subsequent transmission of msg3) and a Cell-Radio Network Temporary Identifier (C-RNTI).

After transmitting the preamble sequence, the UE needs to use a Random Access-Radio Network Temporary Identifier (RA-RNTI) for monitoring Physical Downlink Control Channel (PDCCH) within a RAR window, so as to receive the RAR message. Here,

RA-RNTI=1+t_id+10*f_id

where:
t_id denotes an index of the first subframe of Physical Random Access Channel (PRACH) for transmitting the preamble, (0≦t_id<10);
f_id denotes a frequency domain position index of PRACH within that subframe (0≦f_id<6). For FDD systems, f_id is always zero as there is only one frequency domain position. There is a one-to-one correspondence between RA-RNTIs and time-frequency positions at which the UE transmits the preamble sequence. The UE and the eNB can calculate the RA-RNTI value corresponding to the preamble sequence individually. The UE can receive the RAR message based on the calculated RA-RNTI value. If the preamble sequence identifier in the RAR is the same as the preamble sequence transmitted by the UE itself, the UE can adopt the uplink time adjustment information in the RAR and initiate a corresponding collision resolution procedure.

The RAR window has a length of ra-ResponseWindowSize subframes, starting with the subframe in which the UE transmits the preamble sequence+3 subframes. If the UE fails to receive any RAR as a reply within the period of the RAR window, it considers this as an unsuccessful access. In the RAR message, there may be a back-off indicator (backoffindicator), indicating a time range in which the UE shall wait before retransmitting the preamble. If a particular access has failed, the UE needs to wait a time period before it can perform the next preamble access. This time period is indicated by backoffindicator. The UE can select a value randomly in the range from 0 to backoffindicator. In this way, the probability that the colliding UEs may retransmit the preamble sequence simultaneously again can be reduced.

For an MTC UE with coverage enhancement, it is desired to increase received signal strength of a physical channel for the MTC UE by utilizing enhancement techniques. In the discussion about MTC in Rel-12, the received signal strength of MTC physical channels is increased mainly by means of subframe bundling or repetitive transmissions. MTC UEs at different geographical locations may require different coverage enhancement levels. Accordingly, the MTC UEs in one single cell can be divided into a number of different coverage enhancement levels requiring different numbers of repetitive transmissions, respectively. A coverage enhancement level can also be represented as a repetition level. For example, PRACHs for MTC UEs with coverage enhancement can be divided into four repetition levels, 0, 1, 2 and 3, corresponding to 0 dB, 5 dB, 10 dB and 15 dB of coverage enhancement, respectively. A time interval from a transmission starting subframe to a transmission ending subframe for a particular repetition level is referred to as a repetition window. Then, different repetition levels will have different sizes of repetition windows. A PRACH repetition window for a particular repetition level has RAR transmissions corresponding to the repetition level.

When compared with the conventional LTE system, the Rel-13 LTE system supporting coverage enhanced MTC has a different time granularity for physical channel transmission for MTC UEs with coverage enhancement. The conventional system measures a transmission in time units of subframes, whereas the time granularity for physical channel transmission for coverage enhanced MTC is a repetition window. Hence, for the coverage enhanced MTC, a new solution is desired to obtain an RAR message for the coverage enhanced MTC UE.

### SUMMARY

In a first aspect of the present disclosure, a base station is provided. The base station comprises: a Medium Access Control (MAC) Protocol Data Unit (PDU) generation unit and a transmission unit. The MAC PDU generation unit is configured to generate a MAC PDU consisting of a MAC header and zero or more MAC Random Access Responses (RARs) corresponding to one or more Physical Random Access Channel (PRACH) resource sets. The PRACH resource sets corresponding to the MAC RARs are distinguishable based on PRACH Resource Set Indices (PRIs) in the MAC PDU. The transmission unit is configured to transmit the generated MAC PDU on a Physical Downlink Shared Channel (PDSCH).

The base station in the first aspect of the present disclosure can further comprise: a configuration unit configured to configure, via Radio Resource Control (RRC) signaling, MAC signaling or Physical Broadcast Channel (PBCH), or by means of pre-configuration, resource allocation and other control information for the PDSCH carrying the MAC PDU and/or resource information for RAR (E)PDCCH (i.e., MTC-PDCCH or M-PDCCH).

In a second aspect of the present disclosure, a User Equipment (UE) is provided. The UE comprises a reception unit and a PRACH resource set distinguishing unit. The reception unit is configured to receive a Medium Access Control (MAC) Protocol Data Unit (PDU) on a Physical Downlink Shared Channel (PDSCH). The MAC PDU consists of a MAC header and zero or more MAC Random Access Responses (RARs) corresponding to one or more Physical Random Access Channel (PRACH) resource sets. The PRACH resource sets corresponding to the MAC RARs are distinguishable based on PRACH Resource Set Indices (PRIs) in the MAC PDU. The PRACH resource set distinguishing unit is configured to distinguish the PRACH resource sets corresponding to the MAC RARs based on the PRIs in the received MAC PDU.

The UE in the second aspect of the present disclosure can further comprise an extraction unit configured to extract, via Radio Resource Control (RRC) signaling, MAC signaling or Physical Broadcast Channel (PBCH), or by means of pre-configuration, resource allocation and other control information for the PDSCH carrying the MAC PDU and/or resource information for RAR (E)PDCCH (M-PDCCH).

In a third aspect of the present disclosure, a method performed by a base station is provided. The method comprises: generating a Medium Access Control (MAC) Protocol Data Unit (PDU) consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and transmitting the generated MAC PDU on a Physical Downlink Shared Channel (PDSCH).

The method in the third aspect of the present disclosure can further comprise: configuring, via Radio Resource Control (RRC) signaling, MAC signaling or Physical Broadcast Channel (PBCH), or by means of pre-configuration, resource allocation and other control information for the PDSCH carrying the MAC PDU and/or resource information for RAR (E)PDCCH (M-PDCCH).

In a fourth aspect of the present disclosure, a method performed by a User Equipment (UE) is provided. The method comprises: receiving a Medium Access Control (MAC) Protocol Data Unit (PDU) on a Physical Downlink Shared Channel (PDSCH), the MAC PDU consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and distinguishing the PRACH resource sets corresponding to the MAC RARs based on the PRIs in the received MAC PDU.

The method in the fourth aspect of the present disclosure can further comprise: extracting, via Radio Resource Control (RRC) signaling, MAC signaling or Physical Broadcast Channel (PBCH), or by means of pre-configuration, resource allocation and other control information for the PDSCH carrying the MAC PDU and/or resource information for RAR (E)PDCCH (M-PDCCH).

Optionally, the PDSCH carrying the MAC PDU of RAR cannot be scheduled by an (enhanced) Physical Downlink Control Channel (M-PDCCH). Alternatively, the PDSCH carrying the MAC PDU of RAR can be scheduled by an (enhanced) Physical Downlink Control Channel (M-PDCCH).

Optionally, the PRIs can be identified by information bits within an initial uplink resource allocation field of the MAC RARs. Alternatively, the PRIs are identified by information bits within sub-headers of the MAC PDU. Alternatively, the PRIs are identified by a PRI field following the last MAC RAR, the PRI field having a size dependent on a number of MAC RARs contained in the MAC PDU.

### BRIEF DESCRIPTION OF THE DRAWINGS

The above and other objects, features and advantages will be more apparent from the following description of embodiments with reference to the figures, in which:

FIG. 1 shows a block diagram of a base station according to the present disclosure;

FIG. 2 shows a block diagram of a UE according to the present disclosure;

FIG. 3 is a schematic diagram showing RAR transmission without scheduling by (E)PDCCH (M-PDCCH) according to the present disclosure;

FIG. 4 is a schematic diagram showing RAR transmission with scheduling by (E)PDCCH (M-PDCCH) according to the present disclosure;

FIG. 5 is a schematic diagram showing an existing MAC PDU of RAR in 3GPP LTE;

FIG. 6 is a schematic diagram showing MAC RARs according to the present disclosure;

FIG. 7 is a schematic diagram showing a MAC PDU of RAR according to the present disclosure;

FIG. 8 is a schematic diagram showing MAC PRIs of RAR according to the present disclosure; and

FIG. 9 is a schematic diagram showing MAC PDU sub-headers of RAR according to the present disclosure.

### DETAILED DESCRIPTION

In the following, preferred embodiments of the present disclosure will be described in detail with reference to the drawings. It should be noted that the following embodiments are illustrative only, rather than limiting the scope of the present disclosure. In the following description, details of well known techniques which are not directly relevant to the present invention will be omitted so as not to obscure the concept of the invention.

In the following, a number of embodiments of the present invention will be detailed in an exemplary application environment of LTE mobile communication system and its subsequent evolutions. Herein, it is to be noted that the present invention is not limited to the application exemplified in the embodiments. Rather, it is applicable to other communication systems, such as the future 5G cellular communication system.

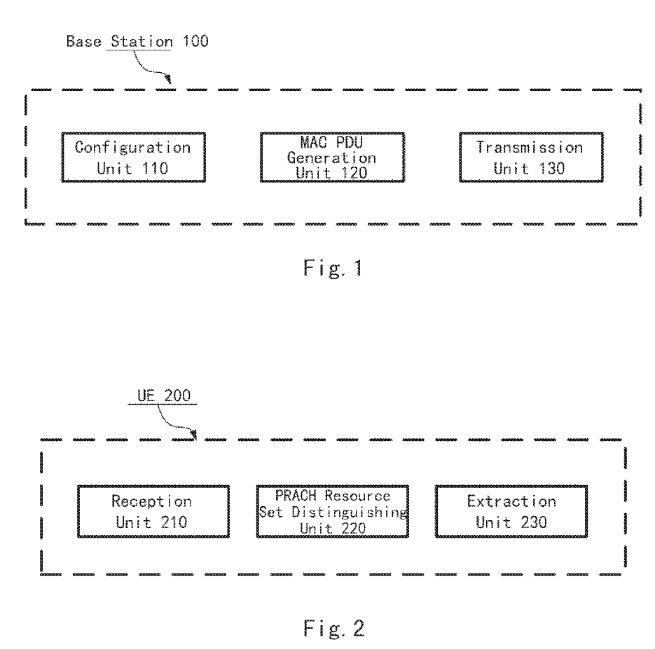

FIG. 1 is a block diagram of a base station 100 according to the present disclosure. As shown, the base station 100 includes a MAC PDU generation unit 120 and a transmission unit 130. The base station can also include a configuration unit 110. It can be appreciated by those skilled in the art that the base station 100 further includes other functional units necessary for its functionality, e.g., various processors, memories and the like. However, details of such well-known elements will be omitted here for simplicity.

The configuration unit 110 can notify an MTC UE of resource allocation and other control information for a PDSCH carrying an RAR message via Radio Resource Control (RRC) signaling, MAC signaling or Physical Broadcast Channel (PBCH), or by means of pre-configuration, such that the MTC UE can receive the RAR message.

The RRC signaling can be common RRC signaling (e.g., System Information Block (SIB)) or dedicated RRC signaling (e.g., UE-specific RRC signaling).

The PBCH can be a PBCH carrying a Master Information Block (MIB) in the conventional LTE system, or a newly designed physical channel for carrying system information. All or part of MTC-related system information can be combined together for transmission on the PBCH.

The resource allocation and other control information for the PDSCH carrying the RAR message can be based on a PRACH coverage enhancement level, a random access preamble sequence or a coverage enhancement level of the RAR message. That is, an eNB can assign different PDSCH resource and other control information for RAR messages having different PRACH coverage enhancement levels. The coverage enhancement level of the PDSCH carrying the RAR message can be dependent on its corresponding PRACH coverage enhancement level, or can be notified to the MTC UE by the eNB via RRC or MAC signaling or PBCH, or by means of pre-configuration.

Alternatively, the resource allocation and other control information for the PDSCH carrying the RAR message can be cell-based. That is, an eNB can assign the same PDSCH resource and other control information for all RAR messages regardless of PRACH coverage enhancement levels.

Alternatively, the resource allocation for the PDSCH carrying the RAR message can be cell-based. That is, an eNB can assign the same PDSCH resource for all RAR messages regardless of PRACH coverage enhancement levels. The other control information can be based on a PRACH coverage enhancement level or a coverage enhancement level of the RAR message.

The resource allocation for the PDSCH carrying the RAR message can be a continuous spectral bandwidth or one or more Physical Resource Blocks (PRBs).

The other control information can include a Transport Block Size (TBS), a start radio frame number and/or subframe number, a number of repetitions, and/or an indication of subframes available for the PDSCH for transmission of the RAR message. The TBS can be indicated by an index of 4 our 5 bits. The eNB can configure one or more TBS values for the PDSCH of the RAR. The indication of subframes available for the PDSCH carrying the RAR message can be implemented by means of bitmapping. That is, for a bit corresponding to a particular subframe, the bit being 1 indicates that the subframe is available for PDSCH transmission, whereas the bit being 0 indicates that the subframe is unavailable for PDSCH transmission.

Alternatively, the configuration unit 110 notifies the MTC UE of resource information of (E)PDCCH (M-PDCCH) via RRC signaling, MAC signaling or PBCH, or by means of pre-configuration.

The (E)PDCCH (M-PDCCH) refers to (E)PDCCH (M-PDCCH) for scheduling the PDSCH carrying the RAR message, i.e., RAR (E)PDCCH (M-PDCCH). This (E)PDCCH (M-PDCCH) can be EPDCCH defined in the conventional LTE system or a newly designed narrowband PDCCH (M-PDCCH).

The resource information of the (E)PDCCH (M-PDCCH) refers to a set of Physical Resource Block (PRB) pairs, or other time-frequency resources, configured by the base station for use by the UE for transmission of (E)PDCCH (M-PDCCH).

The RRC signaling can be common RRC signaling (e.g., System Information Block (SIB)) or dedicated RRC signaling (e.g., UE-specific RRC signaling).

The PBCH can be a PBCH carrying a Master Information Block (MIB) in the conventional LTE system, or a newly designed physical channel for carrying system information. All or part of MTC-related system information can be combined together for transmission on the PBCH.

The resource information of the (E)PDCCH (M-PDCCH) can be based on a PRACH coverage enhancement level, a random access preamble sequence or a coverage enhancement level of the RAR message. That is, an eNB can assign different resource information for RAR (E)PDCCHs (M-PDCCHs) having different PRACH coverage enhancement levels. The coverage enhancement level of the RAR (E)PDCCH (M-PDCCH) can be dependent on its corresponding PRACH coverage enhancement level, or can be notified to the MTC UE by the eNB via RRC or MAC signaling or PBCH, or by means of pre-configuration.

Alternatively, the resource information of the (E)PDCCH (M-PDCCH) can be cell-based. That is, an eNB can assign the same resource information for all RAR (E)PDCCHs (M-PDCCHs) regardless of PRACH coverage enhancement levels.

The MAC PDU generation unit 120 is configured to generate a MAC PDU consisting of a MAC header and zero or more MAC RARs corresponding to one or more PRACH resource sets. The PRACH resource sets corresponding to the MAC RARs are distinguishable based on PRACH Resource Set Indices (PRIs) in the MAC PDU.

The PRACH resource set refers to a set of PRACH resources for a number of repetitive transmissions of a preamble sequence in one random access attempt. Different PRACH coverage enhancement levels have different numbers of repetitive transmissions of the preamble sequence. That is, different PRACH coverage enhancement levels have different sizes of PRACH resource sets.

Alternatively, the MAC PDU generation unit 120 can be configured to generate a MAC PDU consisting of a MAC header and zero or more MAC RARs corresponding to one or more PRACH repetition windows. The PRACH repetition windows corresponding to the MAC RARs are distinguishable based on PRACH repetition window indices in the MAC PDU.

The PRACH repetition window refers to a time interval required for repetitive transmissions of the preamble sequence in one random access attempt at a particular PRACH coverage enhancement level. The PRACH repetition window can be represented by a start radio frame number/subframe number and an end radio frame number/subframe number. Alternatively, the PRACH repetition window can be represented by a start radio frame number/subframe number and the number of repetitive transmissions of the preamble sequence. Different PRACH coverage enhancement levels have different numbers of repetitive transmissions of the preamble sequence. That is, different PRACH coverage enhancement levels have different lengths of PRACH repetition windows.

The transmission unit 130 is configured to transmit the generated MAC PDU on a PDSCH.

Correspondingly to the base station 100 as described above, a method performed by a base station according to the present disclosure includes: generating a Medium Access Control (MAC) Protocol Data Unit (PDU) consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and transmitting the generated MAC PDU on a Physical Downlink Shared Channel (PDSCH). The method can further include: configuring, via Radio Resource Control (RRC) signaling, MAC signaling or Physical Broadcast Channel (PBCH), or by means of pre-configuration, resource allocation and other control information for the PDSCH carrying the MAC PDU.

FIG. 2 is a block diagram of a UE 200 according to the present disclosure. As shown, the UE 200 includes a reception unit 210, a PRACH resource set distinguishing unit 220 and possibly an extraction unit 230. It can be appreciated by those skilled in the art that the UE 200 further includes other functional units necessary for its functionality, e.g., various processors, memories and the like. However, details of such well-known elements will be omitted here for simplicity.

The reception unit 210 is configured to receive a MAC PDU on a PDSCH, the MAC PDU consisting of a MAC header and zero or more MAC RARs corresponding to one or more PRACH resource sets. The PRACH resource sets corresponding to the MAC RARs are distinguishable based on PRACH Resource Set Indices (PRIs) in the MAC PDU.

The PRACH resource set refers to a set of PRACH resources for a number of repetitive transmissions of a preamble sequence in one random access attempt. Different PRACH coverage enhancement levels have different numbers of repetitive transmissions of the preamble sequence. That is, different PRACH coverage enhancement levels have different sizes of PRACH resource sets.

Alternatively, the reception unit 210 can be configured to receive a MAC PDU on a PDSCH, the MAC PDU consisting of a MAC header and zero or more MAC RARs corresponding to one or more PRACH repetition windows. The PRACH repetition windows corresponding to the MAC RARs are distinguishable based on PRACH repetition window indices in the MAC PDU.

The PRACH repetition window refers to a time interval required for repetitive transmissions of the preamble sequence in one random access attempt at a particular PRACH coverage enhancement level. The PRACH repetition window can be represented by a start radio frame number/subframe number and an end radio frame number/subframe number. Alternatively, the PRACH repetition window can be represented by a start radio frame number/subframe number and the number of repetitive transmissions of the preamble sequence. Different PRACH coverage enhancement levels have different numbers of repetitive transmissions of the preamble sequence. That is, different PRACH coverage enhancement levels have different lengths of PRACH repetition windows.

The PRACH resource set distinguishing unit 220 is configured to distinguish the PRACH resource sets corresponding to the MAC RARs based on the PRIs in the received MAC PDU.

In the extraction unit 230, the MTC UE extracts the configuration information to obtain the resource allocation and other control information for the PDSCH carrying the RAR message and/or resource information of RAR (E)PDCCH (M-PDCCH).

Correspondingly to the UE 200 as described above, a method performed by a UE according to the present disclosure includes: receiving a Medium Access Control (MAC) Protocol Data Unit (PDU) on a Physical Downlink Shared Channel (PDSCH), the MAC PDU consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and distinguishing the PRACH resource sets corresponding to the MAC RARs based on the PRIs in the received MAC PDU. The method can further include: extracting, via Radio Resource Control (RRC) signaling, MAC signaling or Physical Broadcast Channel (PBCH), or by means of pre-configuration, resource allocation and other control information for the PDSCH carrying the MAC PDU and/or resource information for RAR (E)PDCCH (M-PDCCH).

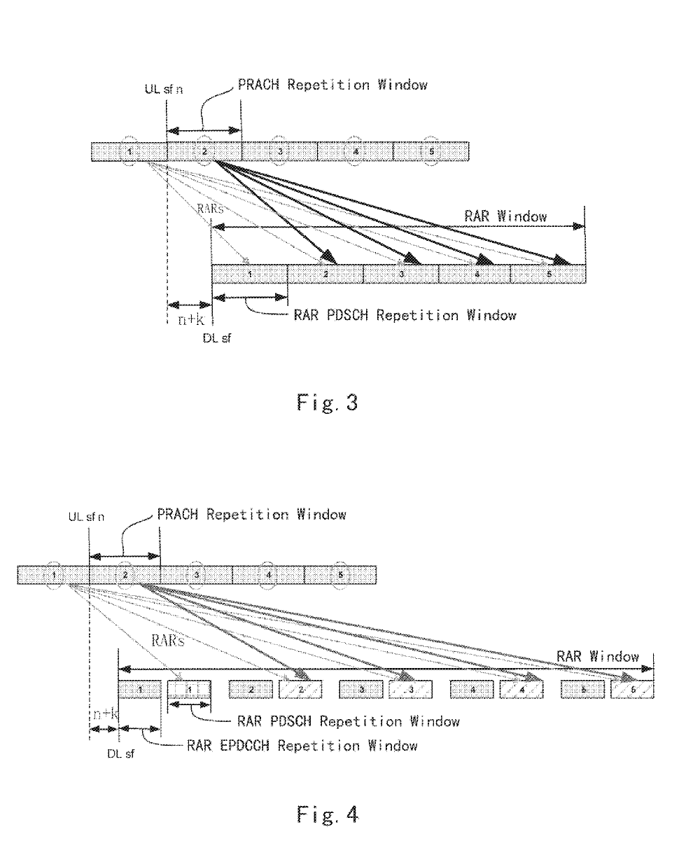

FIG. 3 is a schematic diagram showing RAR transmission without scheduling by (E)PDCCH (M-PDCCH) according to the present disclosure. In this embodiment, there is no need to schedule the PDSCH carrying the RAR via PDCCH. That is, the resource allocation and other control information for the PDSCH carrying the RAR is not signaled to the MTC UE via (E)PDCCH (M-PDCCH), but instead via common RRC signaling (e.g., SIBx), dedicated RRC signaling or MIB, or by means of pre-configuration. Here, SIBx refers to SIB1 and/or SIB2 and/or other SIB.

The PRACH repetition window in FIG. 3 refers to a time interval required for repetitive transmissions of the preamble sequence in one random access attempt at a particular PRACH coverage enhancement level. The PRACH repetition window can be represented by a start radio frame number/subframe number and an end radio frame number/subframe number. Alternatively, the PRACH repetition window can be represented by a start radio frame number/subframe number and the number of repetitive transmissions of the preamble sequence. Alternatively, the PRACH repetition window can be replaced with a PRACH resource or resource set for one random access attempt.

The RAR PDSCH repetition window in FIG. 3 refers to a time interval for a number of repetitive transmissions of PDSCH for the RAR in one random access attempt at a particular PRACH coverage enhancement level, or a time interval for a number of repetitive transmissions of PDSCH for the RAR over a PRACH repetition window or PRACH resource or resource set in one random access attempt at a particular PRACH coverage enhancement level. The RAR PDSCH repetition window can be represented by a start radio frame number/subframe number and an end radio frame number/subframe number. Alternatively, the RAR PDSCH repetition window can be represented by a start radio frame number/subframe number and the number of repetitive transmissions of the RAR PDSCH. The subframes available for RAR transmission in the RAR PDSCH repetition window can be indicated by means of bitmapping. A start subframe of an RAR to a random access attempt shall start transmission of the PDSCH for the RAR at a subframe having a subframe number equal to the subframe number of the subframe at which the random access attempt ends+k. Alternatively, a number of PDSCH repetition windows at fixed positions in time domain can be designed for a particular RAR coverage enhancement level and an RAR to a random access attempt can be transmitted in the first RAR PDSCH repetition window following the k-th subframe after the random access attempt ends.

MAC RARs for preamble sequences identified by the same or different preamble sequence identifiers for different PRACH repetition windows, different PRACH resource sets or different random access attempts, at a particular PRACH coverage enhancement level, can be multiplexed onto one single MAC PDU and transmitted repeatedly over RAR PDSCHs within the RAR PDSCH repetition window corresponding to the PRACH coverage enhancement level.

MAC RARs for different preamble sequences for the same PRACH repetition window, the same PRACH resource set or the same random access attempt, at a particular PRACH coverage enhancement level, can be multiplexed onto one single MAC PDU and transmitted repeatedly over RAR PDSCHs within the RAR PDSCH repetition window corresponding to the PRACH coverage enhancement level.

FIG. 4 is a schematic diagram showing RAR transmission with scheduling by (E)PDCCH (M-PDCCH) according to the present disclosure. In this embodiment, the PDSCH carrying the RAR needs to be scheduled by (E)PDCCH (M-PDCCH). That is, the resource allocation and other control information for the PDSCH carrying the RAR is signaled to the MTC UE via (E)PDCCH (M-PDCCH). It can be seen from the figure that each RAR PDSCH repetition window has a corresponding RAR (E)PDCCH (M-PDCCH) repetition window for carrying the resource allocation and other control information for the RAR PDSCH.

The PRACH repetition window in FIG. 4 refers to a time interval required for repetitive transmissions of the preamble sequence in one random access attempt at a particular PRACH coverage enhancement level. The PRACH repetition window can be represented by a start radio frame number/subframe number and an end radio frame number/subframe number. Alternatively, the PRACH repetition window can be represented by a start radio frame number/subframe number and the number of repetitive transmissions of the preamble sequence. Alternatively, the PRACH repetition window can be replaced with a PRACH resource or resource set for one random access attempt.

The RAR PDSCH repetition window (or (E)PDCCH (M-PDCCH) repetition window) in FIG. 4 refers to a time interval for a number of repetitive transmissions of PDSCH (or (E)PDCCH (M-PDCCH)) for the RAR in one random access attempt at a particular PRACH coverage enhancement level, or a time interval for a number of repetitive transmissions of PDSCH (or (E)PDCCH (M-PDCCH)) for the RAR over a PRACH repetition window or PRACH resource or resource set in one random access attempt at a particular PRACH coverage enhancement level. The RAR PDSCH (or (E)PDCCH (M-PDCCH)) repetition window can be represented by a start radio frame number/subframe number and an end radio frame number/subframe number. Alternatively, the RAR PDSCH (or (E)PDCCH (M-PDCCH)) repetition window can be represented by a start radio frame number/subframe number and the number of repetitive transmissions of the RAR PDSCH (or (E)PDCCH (M-PDCCH)). The subframes available for PDSCH (or (E)PDCCH (M-PDCCH)) transmission in the RAR PDSCH (or (E)PDCCH (M-PDCCH)) repetition window can be indicated by means of bitmapping. A start subframe of an RAR to a random access attempt shall start transmission of the (E)PDCCH (M-PDCCH) for the RAR at a subframe having a subframe number equal to the subframe number of the subframe at which the random access attempt ends+k. The transmission of the RAR PDSCH shall occur following a number of subframes after the transmission of its (E)PDCCH (M-PDCCH) ends. Alternatively, a number of (E)PDCCH (M-PDCCH) (or PDSCH) repetition windows at fixed positions in time domain can be designed for a particular RAR coverage enhancement level and an RAR to a random access attempt can be transmitted in the first RAR (E)PDCCH (M-PDCCH) (or PDSCH) repetition window following the k-th subframe after the random access attempt ends.

MAC RARs for preamble sequences identified by the same or different preamble sequence identifiers for different PRACH repetition windows, different PRACH resource sets or different random access attempts, at a particular PRACH coverage enhancement level, can be multiplexed onto one single MAC PDU and transmitted repeatedly over RAR PDSCHs within the RAR PDSCH repetition window corresponding to the PRACH coverage enhancement level.

MAC RARs for different preamble sequences for the same PRACH repetition window, the same PRACH resource set or the same random access attempt, at a particular PRACH coverage enhancement level, can be multiplexed onto one single MAC PDU and transmitted repeatedly over RAR PDSCHs within the RAR PDSCH repetition window corresponding to the PRACH coverage enhancement level.

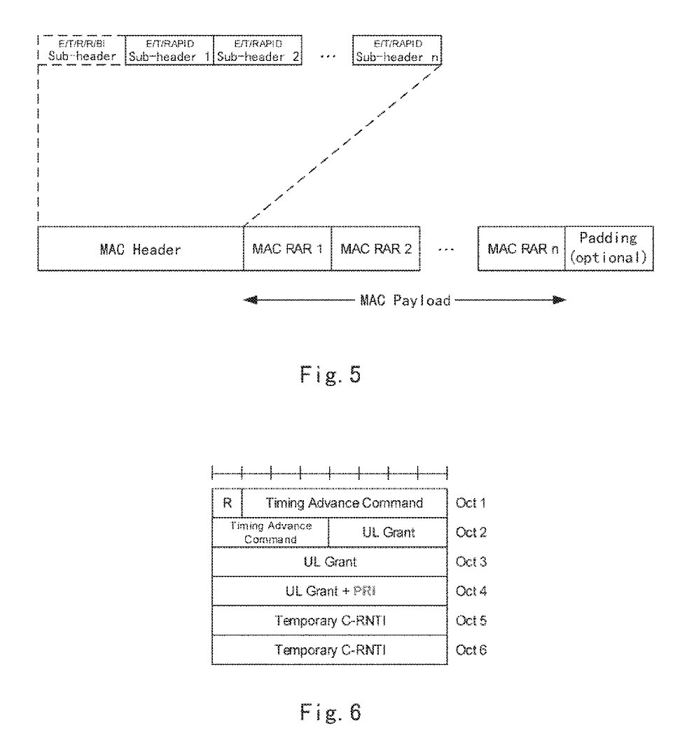

FIG. 5 is a schematic diagram showing an existing MAC PDU of RAR in 3GPP LTE. A MAC PDU of RAR contains one MAC PDU header, zero or more MAC RARs and optional padding. One MAC PDU header contains one or more MAC PDU sub-headers. Each MAC PDU sub-header other than the back-off indicator sub-header corresponds to one MAC RAR. In the conventional system, the MAC PDU sub-header contains a preamble sequence identifier indicating which preamble sequence the RAR is intended for. Moreover, in the conventional LTE system, MAC RARs for preamble sequences transmitted at different times cannot be multiplexed onto one single MAC PDU and only MAC RARs for different preamble sequences transmitted at the same time can be multiplexed onto one single MAC PDU, whereas RARs for preamble sequences transmitted at different times can be distinguished from each other based on RA-RNTIs. In the present disclosure, MAC RARs for preamble sequences identified by the same or different preamble sequence identifiers for different PRACH resource sets (or different PRACH repetition windows or different random access attempts), at a particular PRACH coverage enhancement level, can be multiplexed onto one single MAC PDU. Hence, it is desired to design a scheme for indicating which PRACH resource set (or PRACH repetition window or different random access attempts) the MAC RARs in the MAC PDU belong to. A PRACH resource set indicator can be added in the MAC PDU of the RAR to indicate which PRACH resource set (or PRACH repetition window) a particular MAC RAR corresponds to.

In a first scheme, a PRI can be added to a MAC RAR. FIG. 6 is a schematic diagram showing MAC RARs in this scheme according to the present disclosure. One MAC RAR consists of four fields: a reserved bit (R), a Timing Advance Command, an indication of resources used for transmission of an uplink msg3 (UL grant), and a Temporary C-RNTI. The reserved bit is 1 bit, the Timing Advance Command 11 bits, the UL grant 20 bits, and the Temporary C-RNTI 16 bits. The 20 bits for the UL grant include:
1 bit for a frequency hopping indication;
10 bits for resource allocation of a fixed size;
4 bits for a simplified modulation and coding scheme;
3 bits for a PUSCH power control command;
1 bit for an indication of whether the transmission of PUSCH is delayed; and
1 bit for Channel State Information (CSI).

In the low-cost and coverage enhanced MTC scenario, the MTC UE can transmit at its maximum power. Hence, the 3-bit power control command can be saved. In the LTE Rel-13 system, the MTC UE may only have an uplink bandwidth of 1.4 MHz. Hence, the 10-bit resource allocation information can be reduced. Moreover, the modulation and coding scheme may need less than 4 bits. Thus, a number of bits can be saved from the UL grant field to indicate the PRACH resource set (or PRACH repetition window) corresponding to a particular MAC RAR. Alternatively, the reserved bit and the bits saved from the UL grant can be used to indicate the PRACH resource set (or PRACH repetition window) corresponding to a particular MAC RAR.

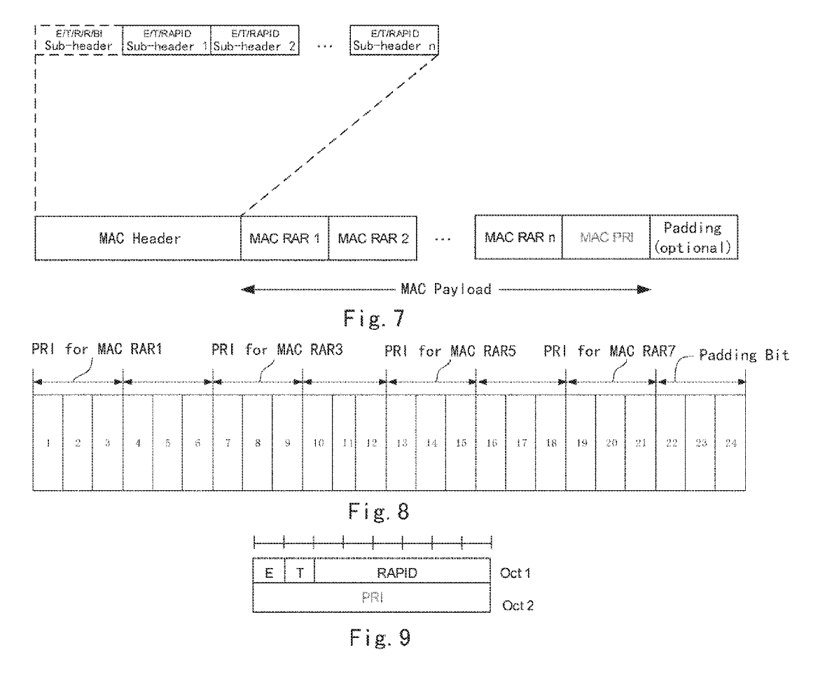

In a second scheme, a MAC PRI field can be appended to the last MAC RAR. FIG. 7 is a schematic diagram showing a MAC PDU of RAR in this scheme according to the present disclosure. It can be seen from the figure that a MAC PRI field can be appended to the last MAC RAR for indicating the PRACH resource sets (or PRACH repetition windows) corresponding to the respective MAC RARs in this MAC PDU. The size of the MAC PRI depends on the number of MAC RARs included in the MAC PDU. For example, if 3 bits are used for indicating the PRACH resource set (or PRACH repetition window) corresponding to a particular MAC RAR and if there are seven MAC RARs included in the MAC PDU, the payload size of the MAC PRI for the MAC PDU is 21 bits. The size of the MAC PRI is a multiple of 8 bits. Hence, the size of the MAC PRI for the MAC PDU is 24 bits. FIG. 8 is a schematic diagram showing MAC PRIs of RAR according to the present disclosure. The MAC PRI has in total 24 bits, including a 21-bit payload and 3 padding bits. The 21 bits include seven groups each containing three bits. The seven groups, arranged in an order, indicate the PRACH resource sets (or PRACH repetition windows) corresponding to MAC RAR1 to MAC RAR7, respectively.

In a third scheme, the PRI can be added to a MAC PDU sub-header. FIG. 9 is a schematic diagram showing RAR MAC PDU sub-headers in this scheme according to the present disclosure. A PRI field is added to each MAC PDU sub-header other than the back-off indicator sub-header, for indicating the PRACH resource set (or PRACH repetition window) corresponding to the RAR.

It can be appreciated that the above embodiments of the present disclosure can be implemented in software, hardware or any combination thereof. For example, the internal components of the base station and the UE in the above embodiments can be implemented using various devices including, but not limited to, analog circuit device, digital circuit device, Digital Signal Processing (DSP) circuit, programmable processor, Application Specific Integrated Circuit (ASIC), Field Programmable Gate Array (FPGA), Programmable Logic Device (CPLD) and the like.

Further, the embodiments of the present disclosure can be implemented in computer program products. More specifically, a computer program product can be a product having a computer readable medium with computer program logics coded thereon. When executed on a computing device, the computer program logics provide operations for implementing the above solutions according to the present disclosure. When executed on at least one processor in a computing system, the computer program logics cause the processor to perform the operations (methods) according to the embodiments of the present disclosure. This arrangement of the present disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules. The software, firmware or arrangement can be installed in a computing device to cause one or more processors in the computing device to perform the solutions according to the embodiments of the present disclosure.

The present disclosure has been described above with reference to the preferred embodiments thereof. It should be understood that various modifications, alternations and additions can be made by those skilled in the art without departing from the spirits and scope of the present disclosure. Therefore, the scope of the present disclosure is not limited to the above particular embodiments but only defined by the claims as attached and the equivalents thereof.

1. A base station, comprising:
a Medium Access Control (MAC) Protocol Data Unit (PDU) generation unit configured to generate a MAC PDU consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and
a transmission unit configured to transmit the generated MAC PDU on a Physical Downlink Shared Channel (PDSCH).

2. The base station of claim 1, wherein the PDSCH carrying the MAC PDU of RAR is not scheduled by an (enhanced) Physical Downlink Control Channel (M-PDCCH).

3. The base station of claim 1, wherein the PDSCH carrying the MAC PDU of RAR is scheduled by an M-PDCCH.

4. The base station of claim 1, wherein the PRIs are identified by information bits within an initial uplink resource allocation field of the MAC RARs.

5. The base station of claim 1, wherein the PRIs are identified by information bits within sub-headers of the MAC PDU.

6. The base station of claim 1, wherein the PRIs are identified by a PRI field following the last MAC RAR, the PRI field having a size dependent on a number of MAC RARs contained in the MAC PDU.

7. The base station of claim 1, further comprising:
a configuration unit configured to configure, via Radio Resource Control (RRC) signaling, MAC signaling or Physical Broadcast Channel (PBCH), or by means of pre-configuration, one or more of:
resource allocation and other control information for the PDSCH carrying the MAC PDU; and
resource information for RAR M-PDCCH.

8. A User Equipment (UE), comprising:
a reception unit configured to receive a Medium Access Control (MAC) Protocol Data Unit (PDU) on a Physical Downlink Shared Channel (PDSCH), the MAC PDU consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and
a PRACH resource set distinguishing unit configured to distinguish the PRACH resource sets corresponding to the MAC RARs based on the PRIs in the received MAC PDU.

9. The UE of claim 8, wherein the PDSCH carrying the MAC PDU of RAR is not scheduled by an (enhanced) Physical Downlink Control Channel (M-PDCCH).

10. The UE of claim 8, wherein the PDSCH carrying the MAC PDU of RAR is scheduled by an M-PDCCH.

11. The UE of claim 8, wherein the PRIs are identified by information bits within an initial uplink resource allocation field of the MAC RARs.

12. The UE of claim 8, wherein the PRIs are identified by information bits within sub-headers of the MAC PDU.

13. The UE of claim 8, wherein the PRIs are identified by a PRI field following the last MAC RAR, the PRI field having a size dependent on a number of MAC RARs contained in the MAC PDU.

14. The UE of claim 8, further comprising:
an extraction unit configured to extract, via Radio Resource Control (RRC) signaling, MAC signaling or Physical Broadcast Channel (PBCH), or by means of pre-configuration, one or more of:
resource allocation and other control information for the PDSCH carrying the MAC PDU; and resource information for RAR M-PDCCH.

15. A method performed by a base station, comprising:
generating a Medium Access Control (MAC) Protocol Data Unit (PDU) consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and
transmitting the MAC PDU on a Physical Downlink Shared Channel (PDSCH).

16. The method of claim 15, further comprising:
configuring, via Radio Resource Control (RRC) signaling, MAC signaling or Physical Broadcast Channel (PBCH), or by means of pre-configuration, one or more of:
resource allocation and other control information for the PDSCH carrying the MAC PDU; and
resource information for RAR M-PDCCH.

17. A method performed by a User Equipment (UE), comprising:
receiving a Medium Access Control (MAC) Protocol Data Unit (PDU) on a Physical Downlink Shared Channel (PDSCH), the MAC PDU consisting of a MAC header and zero or more MAC Random Access Responses (RARs) corresponding to one or more Physical Random Access Channel (PRACH) resource sets, the PRACH resource sets corresponding to the MAC RARs being distinguishable based on PRACH Resource Set Indices (PRIs) in the MAC PDU; and
distinguishing the PRACH resource sets corresponding to the MAC RARs based on the PRIs in the received MAC PDU.

18. The method of claim 17, further comprising:
extracting, via Radio Resource Control (RRC) signaling, MAC signaling or Physical Broadcast Channel (PBCH), or by means of pre-configuration, one or more of:
resource allocation and other control information for the PDSCH carrying the MAC PDU; and
resource information for RAR M-PDCCH.
